(19) United States
(12) Patent Application Publication
(10) Pub. No.: US 2022/0316556 A1
(43) Pub. Date: Oct. 6, 2022

(54) SEGMENTED SHEET JAMMING DEVICES AND COMPONENTS

(71) Applicant: 3M INNOVATIVE PROPERTIES COMPANY, St. Paul, MN (US)

(72) Inventor: Thomas R. Corrigan, St. Paul, MN (US)

(21) Appl. No.: 17/620,878

(22) PCT Filed: Jun. 23, 2020
(86) PCT No.: PCT/IB2020/055927

§ 371 Date: Dec. 20, 2021

Related U.S. Application Data
(60) Provisional application No. 62/865,683, filed on Jun. 24, 2019.

(51) Int. Cl. F16G 13/08; F16G 15/00; F16G 13/18

(52) U.S. Cl. CPC F16G 13/08; F16G 15/00; F16G 13/18

(57) ABSTRACT

A sheet-jammable apparatus having two adjacent segments moveable against each other in a first state when a moving force is applied, and the two adjacent segments remain at a fixed relative position in a second state when the moving force is applied.

### TECHNICAL FIELD

The present disclosure is related to jamming components and devices that can be used for motion resistance.

### SUMMARY

At least some of the embodiments of the present disclosure direct to a sheet-jammable apparatus comprising a set of chains comprising at least one chain. Each of the set of chains comprising a series of connected segments. Two adjacent segments are connected via a joint. Two adjacent segments are moveable against each other in a first state when a moving force is applied and the two adjacent segments remain at a fixed angle in a second state when a moving force is applied.

### BRIEF DESCRIPTION OF DRAWINGS

The accompanying drawings are incorporated in and constitute a part of this specification and, together with the description, explain the advantages and principles of the invention. In the drawings,

FIGS. 1A-1D illustrate several views of one example of a segmented jamming device;

FIG. 2A illustrates one example of a jamming device to be used with a vacuum;

FIGS. 2B-2D each is a cross-section schematic view of a section of an example jamming device;

FIGS. 3A-3D illustrate various examples of segmented jamming devices and chains that can be used in segmented jamming devices;

FIGS. 4A-4B illustrate one example of a segmented jamming device 400 having protruded connectors; and

FIGS. 5A-5C illustrate an experiment of using a segmented jamming device.

In the drawings, like reference numerals indicate like elements. While the above-identified drawings, which may not be drawn to scale, set forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as being “on” “connected to,” “coupled to” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled to,” or “directly in contact with” another element, there are no intervening elements, components or layers for example.

Articles with adjustable stiffness and variable resistance to motion are often needed. For example, a flexible display is bendable and capable of sustaining a bent position. At least some embodiments of the present disclosure are directed to an electrostatic jamming device that generates a controlled resistance to motion. Such a jamming device can be incorporated into various devices, systems, and structures to resist different motions, for example, bending motions, translations, rotations, and the like. The motions can be largely planar, or along or within surfaces.

In some cases, sheets of materials can be jammed together with vacuum to resist motion. In some cases, sheets of materials can be jammed together with electrostatics. This eliminates the need for a vacuum source and gas impermeable envelope. Previous electrostatic jamming devices had several limitations. Some devices enable only simple bending of sheets which can only be shaped into developable surfaces (or a smooth surface with zero Gaussian curvature). The previous devices tend to be difficult to build because they only function at high voltages.

At least some embodiments of the present disclosure direct to a jamming device that can be used to allow bending in one state and resist bending in another state. In some embodiments, the jamming device includes multiple sheets and the sheets can be electrostatically jammed to resist motions. Such jamming device includes conductive layers and dielectric layers disposed between adjacent conductive layers. At least some embodiments of the present disclosure are directed to electrostatic jamming devices that can operate at low voltages yet achieve useful levels of motion resistance. Low voltage refers to a voltage that is lower than the break down voltage of air for the minimal distance between any two oppositely charged conductive layers. Some of the existing jamming devices include dielectric layers that extend well beyond conductive layers to make the shortest path in air between two oppositely charged conductors much longer than the path through the dielectric layer. This makes such jamming devices more difficult to fabricate and susceptible to pin holes or cracks in the dielectric layers because they would create a distance between oppositely charged conductors that would allow breakdown of the air (shorting and arcing). Some embodiments of the jamming devices in the present disclosure are immune to shorting or arcing despite cracks, cuts, pin holes, and other defects in the dielectric layers. In some embodiments, the conductive layers are held at or beyond the thickness of the dielectric layer and the jamming device is operated below the breakdown voltage of air for that distance. In some cases, the low voltage jamming device has the advantage of storing much less energy in the device and being safer for use on and near the human body.

Breakdown voltage refers to the voltage that will cause air to break down and become conductive across a gap of a given distance between two conductors. This is also known as arcing or sparking across the gap. The breakdown voltage varies with pressure. The present disclosure generally refers to the breakdown voltage of air within the range of standard pressures experienced on earth. In the present disclosure, the breakdown voltage refers to the shortest distance through air (not through other dielectric materials) between any two conductors that are not intentionally connected electrically. In the present disclosure, the value of the breakdown voltage at a given distance and pressure has been well studied for years and is generally accepted to follow Pashen's Law at gaps above several micrometers but deviate from it at smaller gaps. The breakdown voltage can be determined using a simplified formula proposed by Babrauskas, Vytenis, Arc Breakdown in Air over Very Small Gap Distances, Interflam 2013, Volume 2, pp. 1489-1498, as provided in Equation (1) below:

$$V = \{ \begin{matrix}178 + 2.48 d + 58 \sqrt{d} , d \geq 7 μ m \\ 337 , 3.5 μ m \leq d < 7 μ m \\ 97 d , d \geq 3 \text{.5} μ m\end{matrix} , \qquad ( 1 )$$

where V is the breakdown voltage in Volt, d is the distance between the two conductors. Breakdown strength, also referred to as dielectric strength, can be understood as the maximum electric field strength (V/m) that does not cause breakdown in the material.

Jammed state is used to describe the condition where relative motions between two adjacent parts, sheets, or structures is resisted by the introduction of an external pressure that squeezes the adjacent parts, sheets, or structures together. The relative motion refers to sliding motion, rotating motion, or translational motion between two adjacent parts, sheets, or structures in the jamming device. There is a spectrum of “jammed” intensity, which requires different forces to overcome the resistance to motion. The external pressure causing the jamming can come from a mechanical source, or application of a vacuum (so atmospheric pressure presses sheets together), from electrostatic attraction between sheets, or the like. Unjammed state, also referred to as loose state, is used to describe the condition where relative motions between adjacent sheets are not given additional resistance.

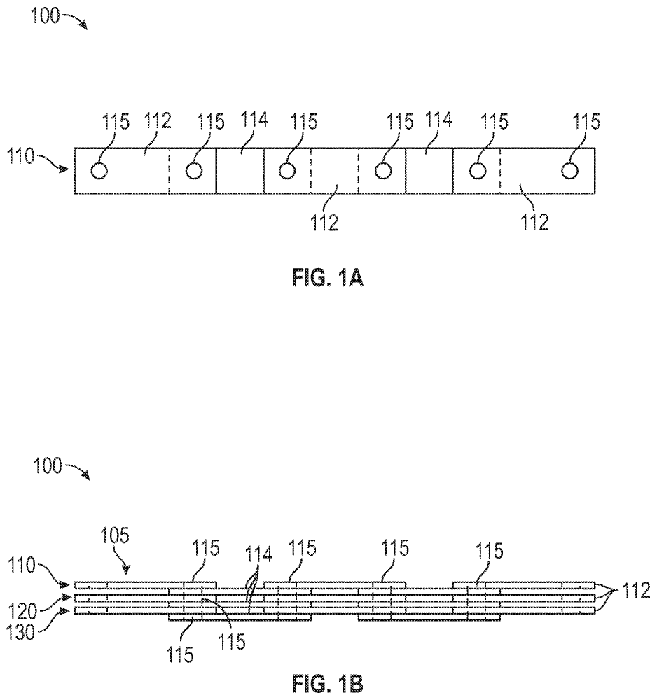

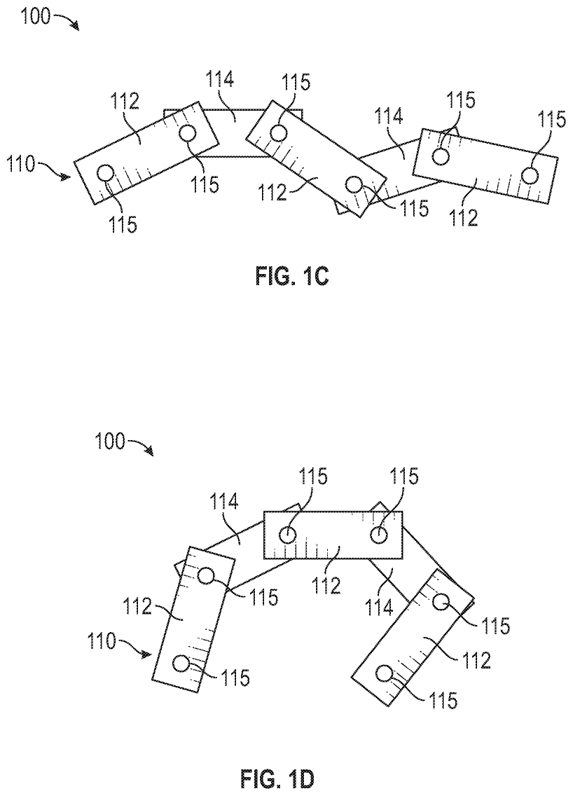

FIG. 1A illustrates a top view of one example of a segmented jamming device 100; FIG. 1B illustrates a side view of the jamming device 100; FIG. 1C illustrates a top view of one rotated position of the jamming device 100; and FIG. 1D illustrates a top view of another rotated position of the jamming device 100. The segmented jamming device 100 includes a set of chains 105 comprising at least one chain 110. In some examples, as illustrated in FIG. 1B the set of chains 105 includes chains 110, 120, and 130. In some embodiments, a chain (e.g., 110) includes a series of connected segments (e.g., 112, 114). In some embodiments, two adjacent segments 112 and 114 are connected via a joint 115. In some embodiments, as illustrated in FIGS. 1C and 1D, two adjacent segments 112 and 114 are rotatable against each other in a first state when a rotating force is applied. In some embodiments, two adjacent segments remain at a fixed angle in a second state when a rotating force is applied.

In some embodiments, the set of chains includes two or more chains (e.g., 110, 120, and 130) disposed in a stacking configuration. In some cases, the two or more chains (e.g., 110, 120, and 130) are stacked via connections at one or more joints (e.g., 115) on the two or more chains.

In some cases, each segment (e.g., 112, 114) includes a plurality of sheets, and each sheet may include a plurality of layers. In some embodiments, each segment is composed of a single material, such as paper; a metal, which can be annealed for enhanced malleability (e.g., steel, aluminum); a polymeric material (e.g., acrylonitrile butadiene styrene, or polyoxymethylene), a composite material (e.g., carbon fiber); other similar suitable materials, and combinations thereof. In some cases, each segment has a structural layer, one or more conductive layers and one or more dielectric layers. The conductive layers of a stack of segments in a jamming device may be electrically connected via wires, mechanical clamps, conductive adhesive or other suitable means.

In some cases, the joint 115 is a revolute joint, or a pin joint. The revolute joint can be created by a pin, rivet, wire, thread or other means passing through open regions of one or more jamming layers on connected segments. Other types of joints can also be used. For example, a pin-in-slot joint could be achieved by changing the shape of the hole on some of the segments. A linear sliding joint could also be created by combining two pin-in-slot joints, or by adding external guiding of the segments.

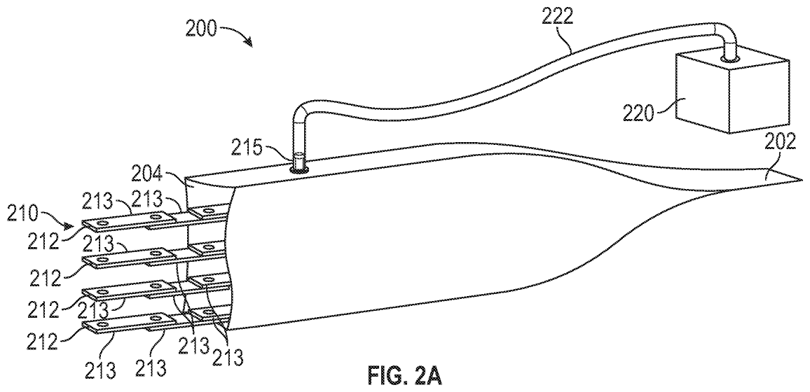

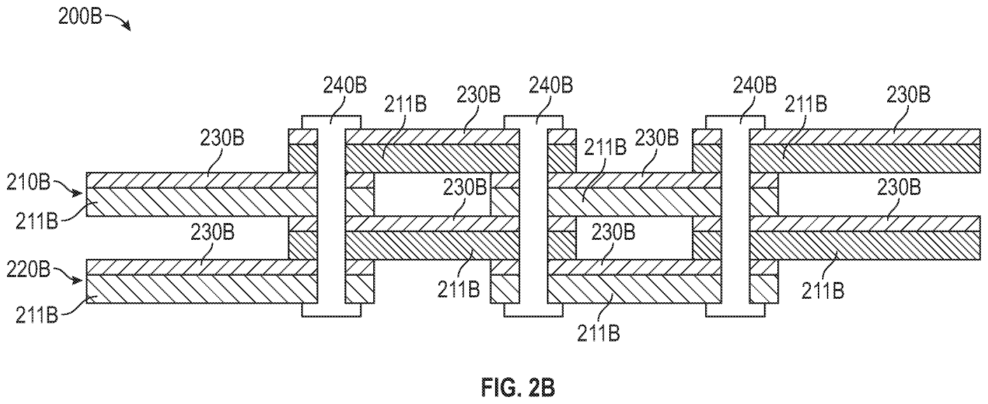

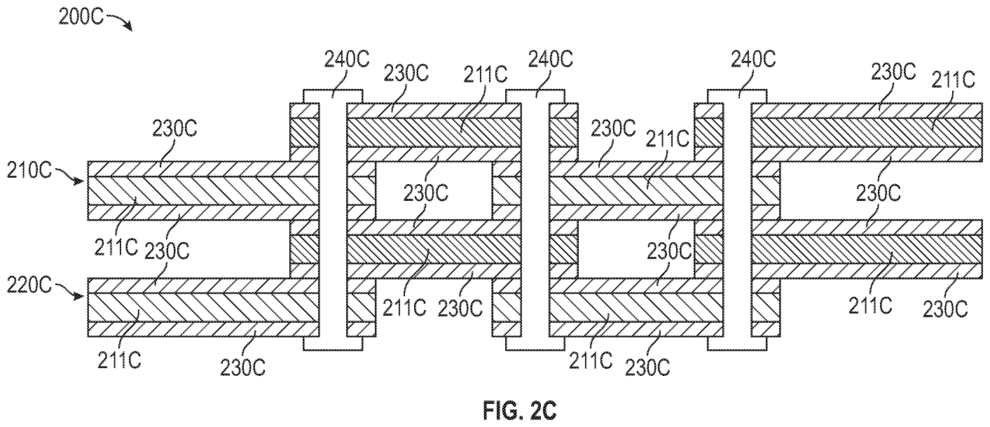

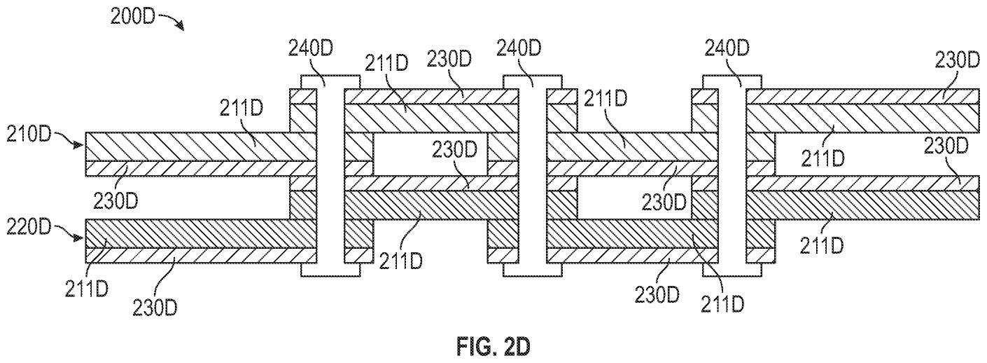

FIG. 2A illustrates one example of a jamming device 200 to be used with a vacuum. In some cases, the jamming device 200 has a segmented jamming device 210 and an envelope (or shell, or pouch) 202. The envelope 202 defines an internal chamber 204. The envelope 202 is formed of a gas-impermeable material. A port 215 is positioned to fluidly couple the chamber 204 with ambiance, and through which the chamber 204 can be evacuated, e.g., by being coupled to a vacuum source 220 through a tube 222. The segmented jamming device 210 is disposed in the chamber 204. In some cases, the segmented jamming device 210 includes one or more chains 212. In some cases, each chain 212 includes two or more connected segments 213.

For clarity purposes, the top and bottom sides of the envelope 202 are illustrated in FIG. 2A as being substantially spaced apart (i.e., with a sidewall joining them). Similarly, the chains 212 are illustrated as being substantially spaced apart from one another. In some cases, the chains 212 can be very close to each other. In some cases, the jamming device 200 can appear much flatter, having a sheet-like or plate-like configuration.

In some embodiments, the jamming device 200 is in a loose state when a pressure inside the envelope 202 is about ambient pressure and in a jammed state is when a pressure inside the envelope is below ambient pressure.

In some cases, the segments in a segmented jamming device include electrostatic sheets. FIG. 2B is a cross-section schematic view of a section of a jamming device 200B having a set of chains. In the embodiment illustrated, the jamming device 200B includes an interdigitated first set of chains 210B and second set of chains 220B. Each of the set of chains has at least two segments. In some cases, two adjacent segments are connected by a joint 240B. In some embodiments, the set of chains of the jamming device 200B are stacked on top of each other and a joint 240B passing through the stack of chains are combined into one. In some cases, each segment of the first set of chain 210B includes a conductive layer 211B. In some cases, each segment of the second chain 220B includes a conductive layer 211B. In some cases, each segment of the jamming device 200B further includes a dielectric layer 230B.

In some embodiments, the jamming device 200B includes a first connector (not illustrated) electrically conductively coupled to the conductive layers 211B of at least part of the segments of the first set of chains 210B and/or the conductive layers 211B of at least part of the segments of the second set of chains 220B. In some cases, the jamming device 200B includes a second connector (not illustrated) electrically conductively coupled to the conductive layers 211B of at least part of the segments of the first set of chains 210B and/or the conductive layers 211B of at least part of the segments of the second chains 220B. In some implementations, the first connector is electrically conductively coupled to conductive layers 211B of every other segment of the first set of chains 210B and the second set of chains 220B, and the second connector is electrically conductively coupled to conductive layers of segments of the first set of chains 210B and the second set of chains 220B between the every other segments coupled to the first connector. In some implementations, the first connector is electrically conductively coupled to the conductive layers 211B of segments of the first set of chains 210B and the second connector is electrically conductively coupled to the conductive layers 211B of segments of the second set of chains 220B.

In some cases, the first set of chains 210B and the second set of chains 220B are movable relative each other in a loose state; and the first set of chains 210B and the second set of chains 220B are jammed with each other in a jammed state. In some cases, the jammed state is induced when a voltage less than or equal to 50V is applied between the first connector and the second connector. In some cases, the jammed state is induced when a voltage less than or equal to 100V is applied between the first connector and the second connector. In some cases, the jammed state is induced when a voltage less than or equal to 200V is applied. In some cases, the jammed state is induced when a voltage less than or equal to a break-down voltage of air for the distance between adjacent conductive layers of one of the first set of chains and one of the second set of chains is applied between the first connector and the second connector.

In some cases, each of the dielectric layers is very thin. In some cases, the thickness of each of the dielectric layers is less than or equal to 10 micrometers. In some cases, the thickness of each of the dielectric layers is less than or equal to 5 micrometers. In some cases, the thickness of each of the dielectric layers is less than or equal to 1 micrometers. In some cases, a distance between the adjacent pair of the conductive layers of adjacent chains in a loose state is no greater than 10 micrometers. In some cases, a distance between the adjacent pair of the conductive layers of adjacent chains in a loose state is no greater than 5 micrometers.

In some embodiments, the conductive layer 211B can include a metal (e.g., copper, aluminum, steel), which can be annealed or hardened, laminated metal layers or foils (e.g., of the same or different metals); a conductive polymer, or a material filled with conductive particles such as carbon. In some embodiments, the chain (210B, 220B) can include a support layer. The support layer can be made from paper or other fibrous material, a polymeric material (e.g., polyurethanes, polyolefins), a composite material (e.g., carbon fiber), an elastomer (e.g., silicone, styrene-butadiene-styrene), or other materials, and combinations thereof. In some cases, the support layer has a thickness no less than 50 micrometers. In some cases, the support layer has a thickness no less than 125 micrometers. In some cases, the support layer and the conductive layer can be combined into one layer. In some cases, the conductive layer 211B is a coating on the structural layer of a segment of the first set of chains 210B and/or the second set of chains 220B. The conductive coating material may be, for example, copper, aluminum, silver, nickel, indium tin oxide, carbon, graphite, or the like. In some embodiments, the dielectric layer can include silicon oxide, aluminum oxide, titanium oxide, mixed metal oxides, mixed metal nitrides, barium titanite, or polymers such as polyimide, acrylates, or the like. In some cases, the dielectric layer can be a dielectric film. In some cases, the dielectric layer 230B is coated on the segments of the first set of chains 210B and/or the second set of chains 220B. The coating material can include silicon oxide, aluminum oxide, titanium oxide, mixed metal oxides, mixed metal nitrides, barium titanite, or polymers such as polyimide, acrylates, or the like.

In some cases, the dielectric layer 230B is very thin. In some cases, the dielectric layer 230B has a thickness less than or equal to 10 micrometers. In some cases, the dielectric layer 230B has a thickness less than or equal to 5 micrometers. In some cases, the dielectric layer 230B has a thickness less than or equal to 1 micrometer. In some cases, the jamming device is jammed with a low voltage. In some cases, the low voltage is no greater than 100V. In some cases, such voltage is less than or equal to a break-down voltage of a distance between the first and the second conductive layer.

Electrostatic jamming can be understood by modeling each set of adjacent oppositely charged conductive layers with dielectric material between them as a parallel plate capacitor. The opposite charge on those layers are attracted to each other. It can be shown that the attractive force creates a compressive pressure on the dielectric material that can be represented by Equation (2):

$$P = \frac{{ε}_{r} {ε}_{0}}{2} \frac{{V}^{2}}{{d}^{2}} , \qquad ( 2 )$$

where εᵣ is the relative permittivity (or dielectric constant) of the dielectric material, ε₀ is the permittivity of free space (or vacuum permittivity or electric constant, 8.854187817 . . . ×10⁻¹² F/m), V is the voltage potential between the two conductive layers, and d is the distance between the two conductive layers (i.e., the thickness of dielectric material(s)).

In some cases, the total thickness of the dielectric material includes one or more layers of dielectric material, and may also include some air gap or debris that was trapped between the conductive layers. When multiple dielectric layers exist (including multiple films, coatings, air, debris, etc) they can be modeled in series. In this case each layer can be modeled as a capacitor with capacitance

$$C = \frac{{ε}_{r} {ε}_{0} A}{d} ,$$

where A is the total area, d is the thickness of that layer, and εᵣ is the relative permittivity of that layer. The total capacitance of the layers in series can be calculated as

$$\frac{1}{{C}_{tot}} = \frac{1}{{C}_{1}} + \frac{1}{{C}_{2}} + \frac{1}{{C}_{3}} + … ,$$

where Cₜₒₜ is the total capacitance and C₁, C₂ . . . are the capacitance of the individual layers. The total jamming pressure on the stack of dielectric material can be calculated as Equation (3):

$$P = ( \frac{{C}_{t o t}}{A} ) \frac{{V}^{2}}{2 ( {d}_{t o t} )} , \qquad ( 3 )$$

where P is the pressure on the stack of dielectric material, Cₜₒₜ is calculated above, dₜₒₜ is the total thickness of the dielectric layers(i.e., the distance between adjacent two conducting layers). An average relative permittivity for this space between conducting layers can also be calculated as Equation (4):

$${ε}_{a v e} = \frac{{d}_{t o t} {C}_{t o t}}{A {ε}_{0}} . \qquad ( 4 )$$

The electrostatic jamming allows sliding motion, both translational and rotational, between oppositely charged conductive layers. The sliding interface can exist between a conductive layer and a dielectric layer, or between a dielectric layer and another dielectric layer. There may be more than one slidable interface between two adjacent oppositely charged conductive layers. When voltage is applied, the pressure created causes the surfaces of the slidable interface to press against each other and resist motion. The resistance to motion can be modeled by considering two interdigitated sets of chains being jammed together. The resistance to sliding two uniform sets of electrostatically jammed chains apart can be calculated as Equation (5):

F=PAμN, (5)

where F is the force required to pull the sets apart (or push them together), A is the area of overlap between the chains (the capacitor area), μ is the coefficient of friction at the sliding interfaces, and N is the total number of interfaces. This is a simplified model, since the areas, frictions and material properties may not be constant, but it is useful to show the primary factors in electrostatic jamming. Although these calculations apply to linear sliding motion, similar calculations can be made for rotational resistance to motion.

It is desireable to have a large jamming pressure that can resist significant forces. For many applications, it is desireable to utilize a very low voltage, which increases the safety, and reduces the cost and energy consumption of the controlling electronics. The jamming performance (i.e., jamming pressure) at very low voltage, according to Equation (2), can be improved by increasing the relative permittivity of the dielectric layers, and by reducing the distance between conductive layers. Using very thin dielectric layers, on the order of a few micrometers or less than one micrometer can enable significant jamming pressures at extra low voltage levels. For example, the International Electrotechnical Commision defines an extra low voltage device to be one that does not exceed 220V d.c. Other standards in the U.K. and USA define extra-low voltage systems as not exceeding 75V d.c. or 60V d.c. Based on the calculations earlier, a pressure approximately 10% of atmospheric pressure can be achieved at 220V if the total thickness of dielectric layers is around 4.4 micrometers (assuming an average relative permittivity of 3). One of the challenges of extra low voltage electrostatic jamming, is that the jamming pressure is reduced by the square of the distance between adjacent oppositely charged conductive layers. If debris or significant airgaps exist in the slidable interface between the conductive layers, the jamming pressure can become too low to achieve a useful resistance to motion, or even to pull the layers together. For example, only 1% of atmospheric pressure is achieved at 220V if the 4.4 micrometer distance above is increased to around 9.6 micrometers by adding a 5.2 micrometer airgap. Therefore, a small dielectric distance is need for appropriate jamming pressure for a jamming device operating at a low voltage. Additionally, an airgap not only increases the total dielectric distance, but also reduces the average relative permittivity causing an even greater reduction in the jamming pressure, according to the above equations. Some embodiments of the present disclosure enable extra low voltage jamming by using very thin dielectric layers and introducing an urging means to bring the chains together to reduce airgaps.

In some cases, the jamming device 200B includes other elements. The jamming device 200B includes one or more urging elements configured to keep the first conductive layer and the second conductive layer close to each other. In some cases, the one or more urging elements is an enclosure that the chains of the jamming device 200B are disposed within. In some cases, the one or more urging elements can be the joints 240B. In some cases, the urging elements are spring elements, such as foam or elastic layers that exert a small pressure on the layers so they maintain light contact and can then be close enough to be jammed together with the application of voltage. In some cases, the gap between conductive layers is filled completely with dielectric material and only a minimal amount of air or other material.

In some cases, the dielectric layer 230B covers less than one hundred percent (100%) of a surface of the segments of the first set of chains 210B and/or the second set of chains 220B. In other words, the jamming device 200B has the conductive layer 211B exposed at a portion of or the entire surface of the chain 200B, which is not covered by dielectric materials at the edge. The exposed conductive layers can facilitate electrical connections. In some cases, the dielectric layer 230B covers less than eighty percent (80%) of a surface of the segments of the first set of chains 210B and/or the second set of chains 220B. In some cases, the dielectric layer 230B covers less than sixty percent (60%) of a surface of the segments of the first set of chains 210B and/or the second set of chains 220B. One challenge for electrostatic jamming devices is protecting the device from electrical breakdown (or dielectric breakdown) of air. Some existing electrostatic jamming devices have used high voltages, from several hundred volts to several thousand volts. This requires the jamming device to include continuous dielectric layers that extended far beyond the conductive layers so that the shortest path between conductive layers in air is many times longer than the path between conductive layers through the dielectric layer. This is because the dielectric strength of air at most voltages is only 3MV/m, while many dielectric materials (such as polyethylene or polyimide) have dielectric strengths of 100 or more MV/m. Some embodiments of the present disclosure, solves this problem by enabling useful jamming pressure with field strengths below the breakdown strength of air. Additional benefit is gained from the fact that the actual breakdown strength of air increases significantly at small gap distances, particularly below 10 micrometers. By operating below the breakdown voltage of air, some embodiments of the present disclosure enable a low cost efficient method of manufacture, where large master rolls of material can be created. Those rolls might include a structural layer, one or more conductive layers, and one or more dielectric layers. The rolls of material can then be cut into many smaller segments of any shape, connected electrically, constrained mechanically as described later, and assembled into finished products, including open and closed chains of segments. Because the electrostatic chain jamming device is operated at a voltage less than the breakdown voltage of air for the thickness of the dielectric material between adjacent oppositely charged conductive layers, such jamming device is protected from electrical breakdown of air that can apear as electric arcing (or arc discharge) and cause melting or burning of material. Another advantage of some embodiments of the present disclosure is immunity to small pinholes or cuts or other imperfections in the dielectric layer. At high voltages, even a small pinhole can cause an electric arc. Some embodiments of the present disclosure enables not only the outer perimeter of jamming chains to be cut without an extended dielectric layer, but it also enables complex patterns to be cut into the jamming chains that increase the conformability of the chains and enable other advantages presented later.

In some cases, the jamming device 200B can include only one chain. In some embodiments, the jamming device 200B can include multiple chains. In some cases, the segments of the chains can be solid or patterned with cuts, e.g., to improve the flexibility (bendability) and/or the extensibility of the chain. In some embodiments, the segments of the chains have patterned cuts to increase the flexibility along one or two axes but to have a desired stiffness along a third axis. In some embodiments, the segments of the chains have patterns cut into them to make them extensible along one or two axes or to allow regions of segments of the chain to move in plane or along a surface relative to other regions. The patterning can be formed by a variety of methods, including but not limited to, steel rule die cutting, extrusion, molding, laser cutting, water jetting, machining, stereolithography or other 3D printing, laser ablation, photolithography, chemical etching, rotary die cutting, stamping, other suitable negative or positive processing techniques, or combinations thereof. Solid and patterned chains of the present disclosure can be single or multi-layer constructions and can be formed of a variety of materials and layers of materials as described above.

The conductive layers and dielectric layers can have various arrangements. One example arrangement of a jamming device 200C is illustrated in FIG. 2C, where each of the conductive layers 211C is sandwiched between two dielectric layers 230C. In this arrangement, a slidable interface exists between two dielectric layers in the unjammed state, and the total dielectric thickness includes the thickness of two dielectric layers 230C, where each dielectric layer 230C can have a distinct thickness, and possibly an air gap. In some cases, the multiple layered construction can be constructed by stacking or laminating the layers. In some cases, the conductive layers are coated or deposited (chemical or physical vapor deposition, for example) onto a core layer. In some cases, the core layer provides structural support. In some cases, the dielectric layers are coated or deposited (chemical or physical vapor deposition, for example) onto the conductive layers. The jamming device 200C has a first set of chains 210C, a second set of chains 220C, and multiple joints 240C, each joint 240C connecting adjacent segments of the first set of chains 210C and the second set of chains 220C.

Another example arrangement of a jamming device 200D is illustrated in FIG. 2D, where conductive layers 211D of adjacent segments in a chain are electrically conductively coupled. The jamming device 200D has a first set of chains 210D, a second set of chains 220D, and multiple joints 240D, each joint 240D connecting adjacent segments of the first set of chains 210D and the second set of chains 220D. Each segment of the chain has a dielectric layer 230D. In some cases, the multiple layered construction can be constructed by stacking or laminating the layers. In some cases, the conductive layers are coated or deposited (chemical or physical vapor deposition, for example) onto a core layer. In some cases, the core layer provides structural support. In some cases, the dielectric layers are coated or deposited (chemical or physical vapor deposition, for example) onto the conductive layers.

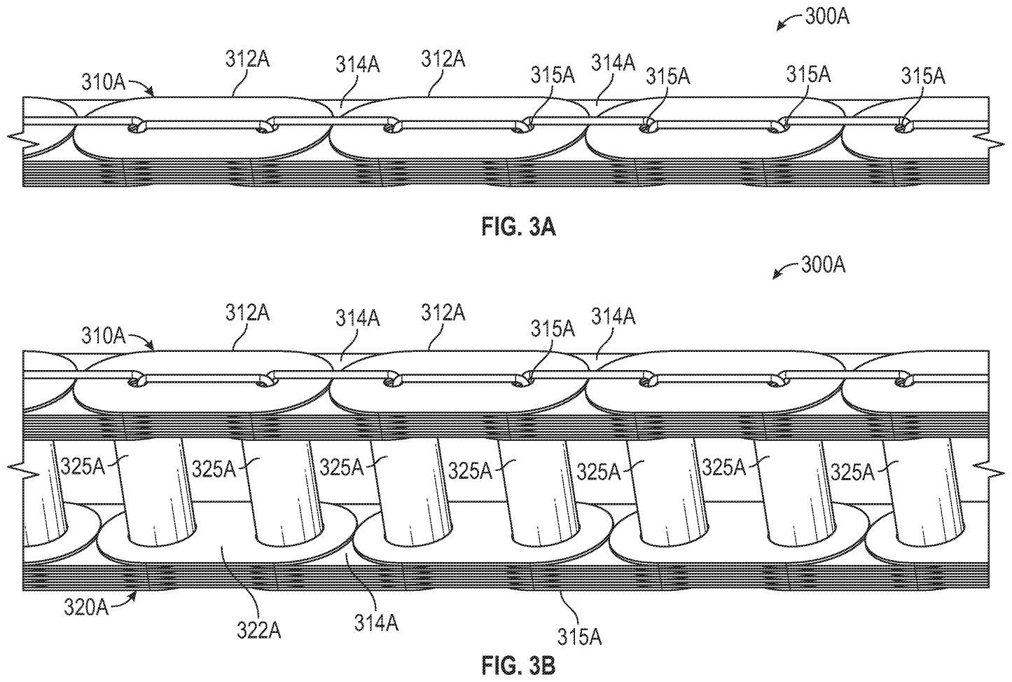

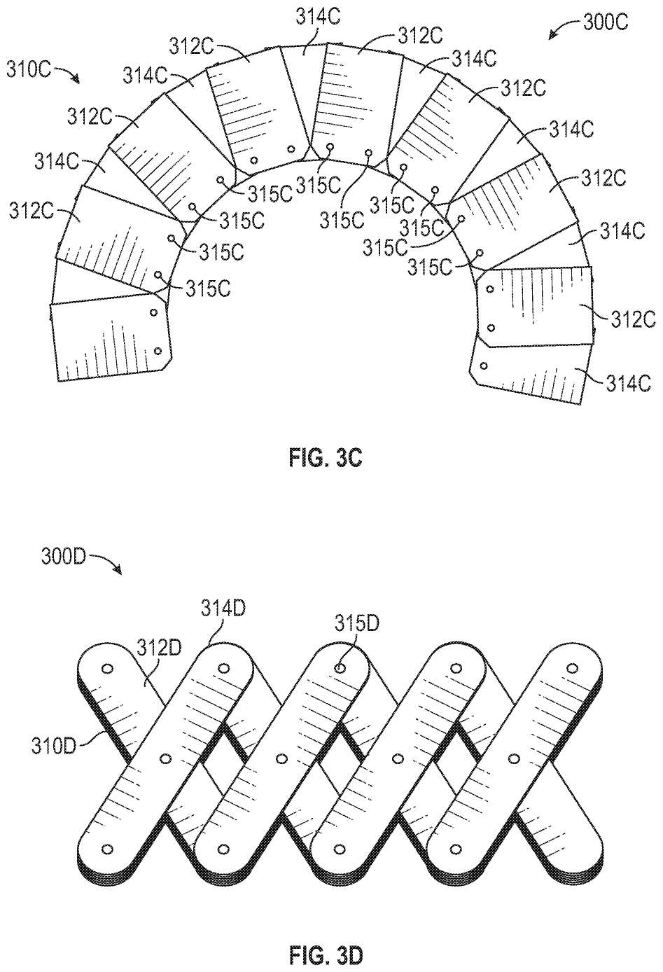

FIGS. 3A-3D illustrate various examples of segmented jamming devices and chains that can be used in segmented jamming devices. FIG. 3A illustrates an example jamming device 300A with sheet-like segments. The jamming device 300A includes one and more chains 310A. Each chain 310A has two or more adjacent segments (312A and 314A) connected via a joint 315A. In this example, the segment (312A, 314A) is a rectangular shape with rounded corners. Each segment has two joints and each joint is proximate at the center of two opposing edges. FIG. 3B illustrates another example of segmented jamming device 300B. The segmented jamming device 300B has a first set of chains 310A and a second set of chains 320A, which can use any one of the embodiments described therein. In one example, each set of chain is similar to the chains illustrated in FIG. 3A, where each chain 310A has two or more segments with adjacent segments (312A and 314A) connected via a joint 315A and each chain 320A has two or more segments with adjacent segments (322A and 324A) connected via a joint 315A. The jamming device 300B has spacer(s) 325A disposed between the two set of chains (310A and 320A).

In some cases, the spacer 325A can be of a rigid material, for example, polycarbonate, PET, polycarbonate, acrylic, or any other rigid or soft plastic. It could also be made of metal such as aluminum, stainless steel, bronze, etc. In one embodiment, the spacer 325A is disposed proximate to the joints (315A). The spacer can increase the second area moment (or moment area of inertia, or second moment of area) of the cross-section and the bending strength of the chain in axes outside of the desired plane of motion. It does this by pushing the relatively thin segments farther apart. In some cases, this chain configuration greatly increases the strength of the chain to resist bending out of the plane of motion.

FIG. 3C illustrates one example chain 300C that can be used in a segmented jamming device. The chain 300C has two or more segments (312C, 314C), and two adjacent segments (312C, 314C) are connected via a joint 315C. In this example, the joints 315C are disposed proximate to one edge of the segments (312C, 314C). In some implementations, this chain configuration provides larger jamming surface and has better resistance to bending. The larger jamming surface area directly increases the force that can be resisted, it can also provide additional surface area for integration and alignment with external components.

More complicated mechanisms can also be created with segmented jamming. Each segment can have more than two joints, and they can be connected into open or closed chain arrangements. Linear joints, pin-in-slot joints and other types of joints can also be employed. A four-bar linkage, or other complex mechanism, could be created for example, that has advantages of controlled motion, high mechanical advantage, prescribed velocity profiles or many other advantages known to one skilled in the art of linkage design. Additional advantages and techniques for employing them are documented in Erdman, Arthur G., et al. Mechanism Design: Analysis and Synthesis. Pearson Education Taiwan, 2004.

FIG. 3D illustrates one example of a more complex mechanism 300D. This arrangement is often referred to as a scissor mechanism. The mechanism 300D has two or more segments (312D, 314D), each segment has three joints 315D connecting an adjacent segment respectively. One advantage of this mechanism is the creation of a linear motion over a large distance with a small motion input. The device can be expanded to cover a large area and then jammed to hold that position and resist external forces.

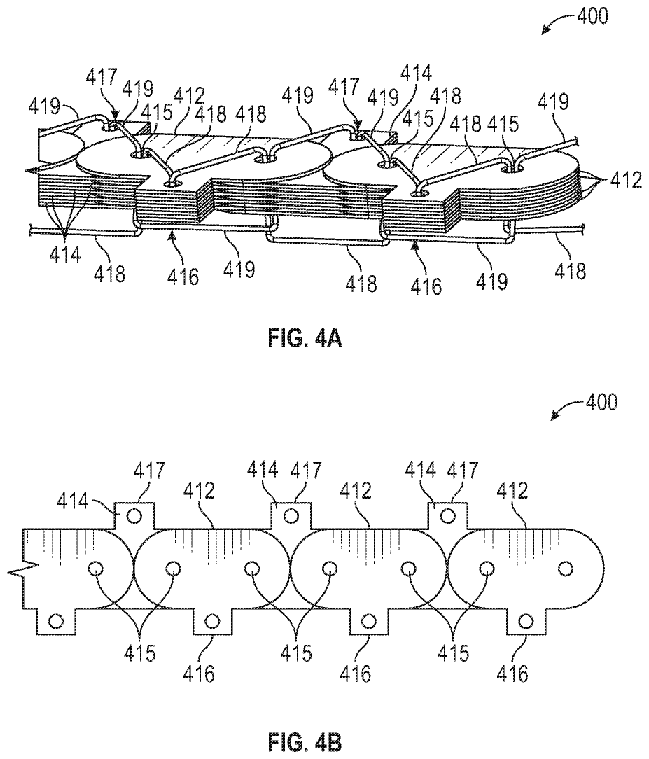

FIGS. 4A-4B illustrate one example of a segmented jamming device 400 having protruded connectors. In this example, the segmented jamming device 400 comprises a first set of segments 412 and second set of segments 414. The segments (412, 414) can have any one of embodiment of segments as described herein. In some implementations, each segment 412 has a protruded connector 416. Each segment 414 has a protruded connector 417. In some cases, a segment 412 is connected with a segment 414 via a joint 415. In some embodiments, the connectors 416 are electrically connected with each other and the connectors 417 are electrically connected with each other. In some embodiments, the connectors 416 and 417 are connected with wires 418 and 419 respectively. In some cases, the wires 418 and 419 are attached to the connectors with conductive epoxy, In some embodiments, the wires pass through holes in the segments, creating the pin joints 415 between adjacent segments. In some cases, a voltage is applied between the connectors 416 and the connectors 417.

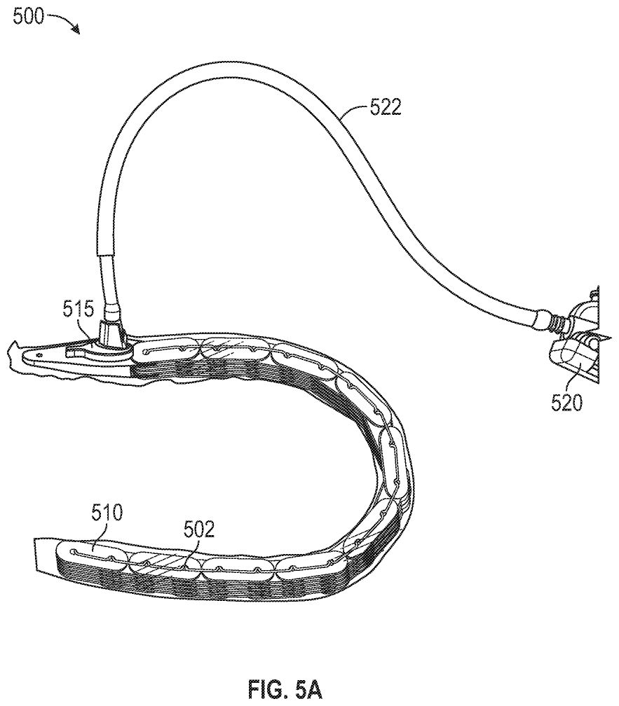

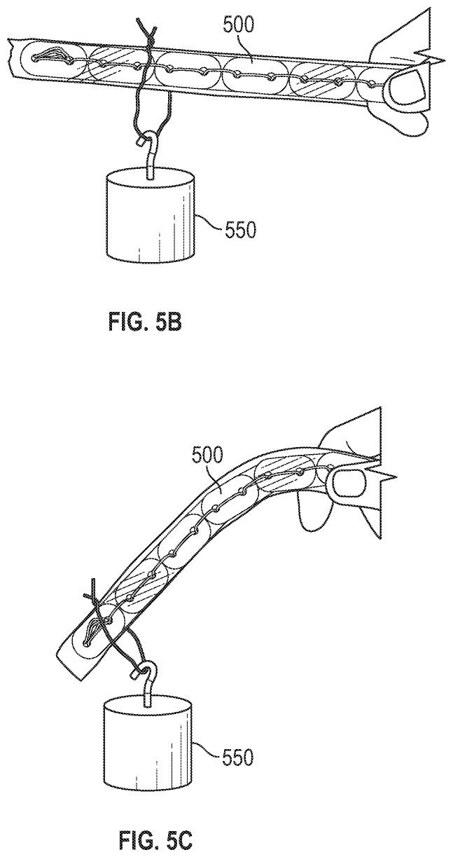

FIGS. 5A-5C illustrate an experiment of using a segmented jamming device 500. The segmented jamming device 500 includes one or more chains 502 disposed in an envelope 510. The envelope 510 has a port 515 connected to a vacuum source 520 via a tube 522. In the illustration of FIG. 5B, the segmented jamming device 500 is in a jammed state, where the pressure in the envelope is below ambient pressure. The segmented jamming device 500 in the jammed state can withheld a certain weight as illustrated. In the illustration of FIG. 5C, the segmented jamming device 500 is in a loose state, where the pressure in the envelope is about ambient pressure. The segmented jamming device 500 in the loose state cannot withhold a certain weight as illustrated.

### Exemplary Embodiments

Item A1. A sheet-jammable apparatus comprising: a set of chains comprising at least one chain, wherein each of the set of chains comprising a series of connected segments, wherein two adjacent segments are connected via a joint, wherein two adjacent segments are moveable against each other in a first state when a moving force is applied, wherein two adjacent segments remain at a fixed angle in a second state when a moving force is applied.

Item A2. The apparatus of Item A1, wherein the set of chains comprise two or more chains disposed in a stacking configuration.

Item A3. The apparatus of Item A2, wherein the two or more chains are stacked via connections at one or more joints on the two or more chains.

Item A4. The apparatus of at least one of Items A1-A3, further comprising: an envelope defining a chamber, the envelope formed of a gas-impermeable material; a port positioned to fluidly couple the chamber; and wherein the at least one chain is disposed in the chamber.

Item A5. The apparatus of Item A4, wherein the second state is when a pressure inside the envelope is below ambient pressure.

Item A6. The apparatus of at least one of Items A1-A5, wherein the set of chains comprises a first set of chains and a set of chains, wherein the first set of chains and the second set of chains are interdigitated.

Item A7. The apparatus of Item A6, wherein each segment of the set of chains comprises a conductive layer.

Item A8. The apparatus of Item A7, wherein each segment of the set of chains comprises a dielectric layer.

Item A9. The apparatus of Item A7, wherein the first set of chains are electrically connected to a first connector, and wherein the second set of chains are electrically connected to a second connector.

Item A10. The apparatus of Item A9, wherein the second state is induced when a voltage is applied between the first connector and the second connector.

Item A11. The apparatus of Item A1, wherein the joint is a revolute joint or a pin joint.

Item A12. The apparatus of Item A1, wherein the set of chains comprises a first set of segments and a second set of segments, wherein one of the first set of segments and one of the second set of segments are connected via a joint.

Item A13. The apparatus of Item A12, wherein each segment of the set of chains comprises a conductive layer.

Item A14. The apparatus of Item A12, wherein each segment of the set of chains comprises a dielectric layer.

Item A15. The apparatus of Item A12, wherein the first set of segments are electrically connected to a first connector, and wherein the second set of segments are electrically connected to a second connector.

Item A16. The apparatus of Item A15, wherein the second state is induced when a voltage is applied between the first connector and the second connector.

Item A17. The apparatus of Item A15, wherein each of the first set of segments comprises a protruded connector.

Item A18. The apparatus of Item A15, wherein each of the second set of segments comprises a protruded connector.

Item B1. A sheet-jammable apparatus comprising: a set of chains comprising at least one chain, wherein each of the set of chains comprising a series of connected segments, an envelope defining a chamber, the envelope formed of a gas-impermeable material; a port positioned to fluidly couple the chamber; and wherein the at least one chain is disposed in the chamber, wherein two adjacent segments are connected via a joint, wherein two adjacent segments are moveable against each other in a first state when a moving force is applied, wherein two adjacent segments remain at a fixed angle in a second state when a moving force is applied.

Item B2. The apparatus of Item B1, wherein the set of chains comprise two or more chains disposed in a stacking configuration.

Item B3. The apparatus of Item B2, wherein the two or more chains are stacked via connections at one or more joints on the two or more chains.

Item B4. The apparatus of at least one of Items B1-B3, wherein the second state is when a pressure inside the envelope is below ambient pressure.

Item B5. The apparatus of at least one of Items B1-B4, wherein the joint is a revolute joint or a pin joint.

Item C1. A sheet-jammable apparatus comprising: a set of chains comprising at least one chain, wherein the set of chains comprises a first set of segments and a second set of segments, wherein one of the first set of segments and one of the second set of segments are connected via a joint, wherein the first set of segments are electrically conductively coupled to a first connector, wherein the second set of segments are electrically conductively coupled to a second connector wherein each segment of the set of chains comprises a conductive layer, wherein each of the set of chains comprising a series of connected segments, wherein two adjacent segments are moveable against each other in a first state when a moving force is applied, wherein two adjacent segments remain at a fixed angle in a second state when a moving force is applied.

Item C2. The apparatus of Item C1, wherein the set of chains comprise two or more chains disposed in a stacking configuration.

Item C3. The apparatus of Item C2, wherein the two or more chains are stacked via connections at one or more joints on the two or more chains.

Item C4. The apparatus of any one of Items C1-C3, wherein the second state is induced when a voltage is applied between the first connector and the second connector.

Item C5. The apparatus of any one of Items C1-C4, wherein the joint is a revolute joint or a pin joint.

Item C6. The apparatus of any one of Items C1-C5, wherein each segment of the set of chains comprises a dielectric layer.

Item C7. The apparatus of any one of Items C1-C6, wherein each of the first set of segments comprises a protruded connector.

Item C8. The apparatus of any one of Items C1-C7, wherein each of the second set of segments comprises a protruded connector.

What is claimed is:

1. A sheet-jammable apparatus comprising:
a set of chains comprising at least one chain, wherein each of the at least one chain comprises a plurality of connected segments,
wherein the plurality of connected segments comprises adjacent segments, and the adjacent segments are connected via a joint,
wherein in a first state, the adjacent segments are rotatably moveable relative to one other when a moving force is applied,
wherein in a second state, the adjacent segments remain at a fixed angle relative to one another when the moving force is applied.

2. The sheet-jammable apparatus of claim 1, wherein the set of chains comprises two or more chains disposed in a stacking configuration.

3. The sheet-jammable apparatus of claim 2, wherein the two or more chains are stacked via connections at one or more joints on the two or more chains.

4. The sheet-jammable apparatus of claim 1, further comprising:
an envelope defining a chamber, the envelope formed of a gas-impermeable material;
a port positioned to fluidly couple the chamber; and
wherein the set of chains is disposed in the chamber.

5. The sheet-jammable apparatus of claim 4, wherein the second state comprises a pressure inside the envelope that is below ambient pressure.

6. The sheet-jammable apparatus of claim 1, wherein the set of chains comprises a first set of chains and a second set of chains, wherein the first set of chains and the second set of chains are interdigitated.

7. The sheet-jammable apparatus of claim 6, wherein each segment of the set of chains comprises a conductive layer.

8. The sheet-jammable apparatus of claim 7, wherein each segment of the set of chains comprises a dielectric layer.

9. The sheet-jammable apparatus of claim 7, wherein the first set of chains are electrically connected to a first connector, and wherein the second set of chains are electrically connected to a second connector.

10. The sheet-jammable apparatus of claim 9, wherein the second state is induced when a voltage is applied between the first connector and the second connector.

11. The sheet-jammable apparatus of claim 1, wherein the joint is selected from a revolute joint and a pin joint.

12. The sheet-jammable apparatus of claim 1, wherein the set of chains comprises a first set of segments and a second set of segments, wherein one of the first set of segments and one of the second set of segments are connected via a joint.

13. The sheet-jammable apparatus of claim 12, wherein each segment of the set of chains comprises a conductive layer.

14. The sheet-jammable apparatus of claim 12, wherein each segment of the set of chains comprises a dielectric layer.

15. The sheet-jammable apparatus of claim 12, wherein the first set of segments are electrically connected to a first connector, and wherein the second set of segments are electrically connected to a second connector.

16. The sheet-jammable apparatus of claim 15, wherein the second state is induced when a voltage is applied between the first connector and the second connector.

17. The sheet-jammable apparatus of claim 15, wherein each of the first set of segments comprises a protruded connector.

18. The sheet-jammable apparatus of claim 15, wherein each of the second set of segments comprises a protruded connector.
